(19) United States
(12) Patent Application Publication
(10) Pub. No.: US 2002/0090125 A1
(43) Pub. Date: Jul. 11, 2002

(54) Method and apparatus for handling image data

(75) Inventor: Masayuki Murakami, Kaisei-machi (JP)

Correspondence Address: SUGHRUE, MION, ZINN,, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/014,506

(22) Filed: Dec. 14, 2001

(30) Foreign Application Priority Data
Jan. 10, 2001 (JP) 002244/2001

(51) Int. Cl. G06K 9/00

(52) U.S. Cl. 382/130

(57) ABSTRACT

Energy subtraction processing can be carried out easily in an image data handing apparatus. In the image data handing apparatus, a low-energy image data set and a high-energy image data set are input from a buffer memory, and energy subtraction processing is carried out thereon by ES processing means to generate an energy subtraction image data set. An image based on the energy subtraction image data set is displayed on a display unit. The image data handling apparatus comprises information addition means for adding combination information indicating that the low-energy image data set belongs to the same combination as the high-energy image data set.

### BACKGROUND OF THE INVENTION

1. Field of the Invention

The present invention relates to an image data handling method and to an image data handling apparatus. More specifically, the present invention relates to an image data handling method and to an image data handling apparatus for handling a plurality of image data sets representing radiation images and an energy subtraction image data set obtained by subtraction processing on the image data sets.

2. Description of the Related Art

Radiation image recording/reproducing systems using stimulable phosphor have been known (see Japanese Unexamined Patent Publication Nos. 55(1980)-12429, 56(1981)-11395, and 56(1981)-11397, for example). Stimulable phosphor stores a portion of energy of radiation (such as X rays, α rays, β rays, γ rays, electron rays, and ultraviolet rays) irradiated thereon, and emits a phosphorescent light corresponding to the energy stored therein, when an excitation light such as a visible light is irradiated thereon. In a radiation image information recording/reproducing system, radiation image information of a subject such as a human body is recorded in a stimulable phosphor sheet having a stimulable phosphor layer, and the sheet is scanned with the excitation light such as a laser beam to cause the sheet to emit the phosphorescent light. The phosphorescent light is photoelectrically read to obtain an image signal, and a radiation image of the subject is recorded as a visible image on a recording medium such as a photosensitive material or displayed on a display apparatus such as a CRT display, based on the image signal.

Meanwhile, energy subtraction for obtaining an energy subtraction image data set by extracting a specific structural component of a subject has also been known. In energy subtraction, radiation that has passed through the subject including a plurality of structural components having different radiation energy absorption characteristics is irradiated on two stimulable phosphor sheets to record radiation images of the subject therein. A low-energy image data set and a high-energy image data set respectively read from the two stimulable phosphor sheets are subjected to subtraction processing, and the specific component is extracted to obtain the energy subtraction image data set.

The energy subtraction described above uses the fact that the plurality of structural components in the subject, such as bones and soft-tissue in a human body, have different absorptivities for radiation having different levels of energy. By photographing with low-energy radiation and high-energy radiation that has passed through the subject, two image data sets (the low-energy image data set and the high-energy image data set) of the subject are obtained. By carrying out the energy subtraction processing on the image data sets, that is, by carrying out subtraction between the image data sets after appropriately weighting the image data sets, the energy subtraction image data set representing a bone image or a soft-tissue image extracting the bones or the soft-tissue as the specific structural component in the subject (that is, a bone image data set or a soft-tissue image data set) can be obtained (see U.S. Pat. Nos. 4,855,598 and 4,896,037, for example).

More specifically, when energy subtraction is carried out for obtaining a radiation image of a bronchus for example, an image of the ribs can be displayed more dimly together with the image of the bronchus as a target of observation. Therefore, an image preferable for observation of soft-tissue such as the bronchus can be obtained, although the bronchus has been conventionally observed in a state of overlap with the bones.

The low-energy radiation and the high-energy radiation are distinguished from each other by comparing a ratio of a high-energy component to a low-energy component in at least two types of radiation when energy components of the at-least-two types of radiation are divided by using a threshold value. Among the at-least-two types of radiation, the high-energy radiation refers to radiation having a higher ratio of the high-energy component to the low-energy component (high/low), while the low-energy radiation has a lower ratio thereof. Image information obtained by photographing with the low-energy radiation is referred to as low-energy image information, while image information obtained by photographing with the high-energy radiation is referred to as high-energy image information. Image data sets obtained by reading the low-energy image information and the high-energy image information are respectively called the low-energy image data set and the high-energy image data set. Images generated from the low-energy image data set and the high-energy image data set are respectively referred to as a low-energy image and a high-energy image.

Definition of the low-energy radiation and the high-energy radiation is applicable to radiation before entering the stimulable phosphor sheet or a radiation image detector such as a solid-state radiation sensor.

Meanwhile, an apparatus can be proposed for recording in a recording medium the low-energy image data set and the high-energy image data set obtained by photographing with radiation and for generating the energy subtraction image data set by using the low-energy image data set and the high-energy image data set. In such an apparatus, the low-energy image data set and the high-energy image data set obtained by photographing with radiation are stored separately in the recording medium. Thereafter, in the case where a detailed bone image or a detailed soft-tissue image is needed as a result of observation of the image generated by the low-energy image data set for example, energy subtraction processing needs to be carried out on the low-energy image data set and the high-energy image data set for the same subject obtained at the same time. However, even if an operator tries to read the high-energy image data set to be paired with the low-energy image data set from the recording medium, the high-energy image data set is not easily read due to a complex operation necessary for reading a specific image data set set.

Furthermore, when the soft-tissue image obtained by energy subtraction processing is displayed, the soft-tissue organ may not be easy to observe due to the bones displayed together and not eliminated sufficiently. In this case, energy subtraction processing using a different subtraction parameter value needs to be carried out on the low-energy image data set and the high-energy image data set used for generating the image being observed (hereinafter referred to as original image data set pair) so that a soft-tissue image having the dimmer bone image and thus appropriate for observation can be displayed. However, the original image data set pair is also not easy to read, since a complex operation is necessary to read the original image data set pair used for generating the soft-tissue image.

In consideration of the situation described above, it has been desired to carry out energy subtraction processing by easily finding either the low-energy image data set or the high-energy image data set to be paired with the other or by easily finding the original image data set pair used for generating the soft-tissue image data set or the bone image data set.

In some cases, the low-energy image data set and the high-energy image data set obtained by photographing with radiation are transferred from the apparatus to a filing apparatus or the like and stored therein. Thereafter, energy subtraction processing is carried out by reading the low-energy image data set and the high-energy image data set from the filing apparatus. In other cases, the low-energy image data set and the high-energy image data set are transferred to a workstation or the like having a function of carrying out the energy subtraction processing, and the energy subtraction processing is carried out therein.

The problem of complex image-data finding operation is also common between the cases described above, that is, the case of carrying out the energy subtraction processing by reading the low-energy image data set and the high-energy image data set stored in a specific apparatus such as the filing apparatus connected via a network, and the case of carrying out the energy subtraction processing in an apparatus such as the workstation that receives the low-energy image data set and the high-energy image data set transferred thereto.

### SUMMARY OF THE INVENTION

The present invention has been conceived based on consideration of the above problem. An object of the present invention is therefore to provide an image data handling method and an image data handling apparatus for enabling energy subtraction processing to be carried out easily.

An image data handling method of the present invention is a method of handling a low-energy image data set and a high-energy image data set used for generating an energy subtraction image data set, and the image data handling method comprises the step of adding combination information to the low-energy image data set and the high-energy image data set for indicating that the low-energy image data set belongs to the same combination as the high-energy image data set.

The combination information can be added to the energy subtraction image data set generated from the low-energy image data set and the high-energy image data set, for indicating that the energy subtraction image data set belongs to the same combination as the low-energy image data set and the high-energy image data set.

Another image data handling method of the present invention is a method of handling an energy subtraction image data set generated from a low-energy image data set and a high-energy image data set, and the method comprises the step of adding image data set specification information to the energy subtraction image data set for specifying the low-energy image data set and the high-energy image data set used for generating the energy subtraction image data set.

An image data handling apparatus of the present invention is an apparatus for handling a low-energy image data set and a high-energy image data set used for generating an energy subtraction image data set, and the image data handling apparatus comprises information addition means for adding combination information to the low-energy image data set and the high-energy image data set for indicating that the low-energy image data set belongs to the same combination as the high-energy image data set.

The information addition means may add energy distinction information to the low-energy image data set and the high-energy image data set for distinguishing the low-energy image data set from the high-energy image data set. Alternatively, the information addition means may add subtraction target information to the low-energy image data set and the high-energy image data set for indicating that the low-energy image data set and the high-energy image data set are used for generating the energy subtraction image data set. Furthermore, the information addition means may add the combination information to the energy subtraction image data set generated from the low-energy image data set and the high-energy image data set for indicating that the energy subtraction image data set belongs to the same combination as the low-energy image data set and the high-energy image data set.

As the combination information, patient examination information may be used for indicating that the same patient and the same examination are used for generating the image data sets, for example.

The information addition means may add the combination information as series information. A series refers to a hierarchal level in a hierarchal structure of information to be added for image classification. The series information comprises information on a patient, an examination, and an individual image, for example.

The image data handling apparatus may further comprise display means for displaying a low-energy image based on the low-energy image data set, a high-energy image based on the high-energy image data set, and an energy subtraction image based on the energy subtraction image data set, and switching means for changeover display of the above images on the display means. Moreover, the image data handling apparatus may also comprise subtraction parameter changing means for changing a value of a subtraction parameter used for generating the energy subtraction image data set, and energy subtraction processing means for generating the energy subtraction image data set from the low-energy image data set and the high-energy image data set by using the subtraction parameter.

The subtraction parameter described above is a parameter used for operation of energy subtraction processing carried out on the low-energy image data set and the high-energy image data set. More specifically, parameters such as ELV, ECS, ETC, and EQS can be used, for example. ELV is a parameter for changing a degree of separation of bones and a soft-tissue organ in a stepwise manner. More specifically, ELV is used for causing an image of ribs in an image of bronchus or lungs as the soft-tissue organ to become dimmer. ECS is an auxiliary parameter corresponding to ELV, and used for calculating a coefficient for interpolation processing on ELV. ETC is a parameter for stabilizing density. More specifically, ETC is used for reducing the contrast of a soft-tissue image in a bone image. EQS is a parameter for reducing noise by changing a smoothing mask size, for example.

The image data handling apparatus may further comprise image processing means for carrying out image processing on the image data sets representing the above images, and image processing parameter changing means for changing an image processing parameter used for carrying out the image processing in the image processing means.

The image processing in the above refers to tone processing for displaying the images in sharp contrast, frequency processing for displaying the images by enhancing a structural component having a specific space frequency, and standardization processing for displaying the images in a constant average density, for example. The image processing parameter is a parameter used for carrying out the image processing and refers to a parameter for adjusting a degree of sharpening the contrast or a degree of enhancing the structural component having the specific space frequency, for example.

Another image data handling apparatus of the present invention is an apparatus for handling an energy subtraction image data set generated from a low-energy image data set and a high-energy image data set, and the image data handling apparatus comprises information addition means for adding image data set specification information to the energy subtraction image data set for specifying the low-energy image data set and the high-energy image data set used for generating the energy subtraction image data set.

According to one of the image data handling methods and one of the image data handling apparatuses of the present invention, the combination information is added to the low-energy image data set and the high-energy image data set used for generating the energy subtraction image data set, in order to indicate that the low-energy image data set and the high-energy image data set belong to the same combination. Therefore, the image data sets belonging to the same combination can be easily distinguished from image data sets belonging to another combination. Furthermore, either the low-energy image data set or the high-energy image data set of the same combination can be immediately found from the other image data set having the same combination information, without a complex operation. Moreover, energy subtraction processing using the low-energy image data set and the high-energy image data set of the same combination, that is, energy subtraction processing using an original image data set pair, can be carried out easily in a short time.

If the information addition means adds the energy distinction information to the low-energy image data set and the high-energy image data set for distinction between the image data sets, the low image data set can be distinguished immediately from the high-energy image data set in the same combination. Therefore, energy subtraction processing can be carried out more easily on the low-energy image data set and the high-energy image data set.

If the information addition means adds the subtraction target information to the low-energy image data set and the high-energy image data set for indicating that the image data sets are used for generating the energy subtraction image data set, the low-energy image data set and the high-energy image data set belonging to the same combination for generating the energy subtraction image data set are found among low-energy image data sets and high-energy image data sets excluding image data sets not used for energy subtraction processing. Therefore, the energy subtraction processing can be carried out more easily.

If the information addition means adds the combination information to the energy subtraction image data set generated from the low-energy image data set and the high-energy image data set for indicating that the energy subtraction image data set belongs to the same combination as the other sets, or if the information addition means adds the combination information as the series information to the energy subtraction image data set, the original image data set pair can be found from any one of the image data sets belonging to the same combination, and the energy subtraction processing can be carried out easily.

If the image data handling apparatus comprises the display means enabling display of the low-energy image based on the low-energy image data set, the high-energy image based on the high-energy image data set, and the energy subtraction image based on the energy subtraction image data set, and the switching means for changeover display of the images on the display means, the images can be displayed as necessary through a simple operation.

If the image data handling apparatus further comprises the subtraction parameter changing means for changing the value of the subtraction parameter used for generating the energy subtraction image data set, the subtraction parameter for carrying out the subtraction processing can be set in a simpler operation. In this manner, the energy subtraction processing can be carried out more easily.

If the image data handling apparatus comprises the image processing means for carrying out the image processing on the image data sets representing the images displayed on the display means and the image processing parameter changing means for changing the image processing parameter used in the image processing means, the image processing can be carried out on the images through a simple operation, and the images more appropriate for observation can be displayed.

According to the other image data handling method and the other the image data handling apparatus of the present invention, the information addition means is used for adding the image data set specification information to the energy subtraction image data set in order to specify the low-energy image data set and the high-energy image data set used for generating the energy subtraction image data set. Therefore, based on the image data set specification information added to the energy subtraction image data set, the low-energy image data set and the high-energy image data set used for generating the energy subtraction image data set can be read immediately, and the subtraction processing using the original image data set pair can be carried out easily in a short time.

### BRIEF DESCRIPTION OF THE DRAWINGS

FIG. 1 is a block diagram showing a configuration of an embodiment of an image data handling apparatus of the present invention;

FIG. 2 shows an operation panel;

FIG. 3 shows a combination information format;

FIG. 4 shows a state where time has been recorded in a Time field of the combination information format;

FIG. 5 shows a state where the same EsSource number has been assigned to a pair of original image data sets; and

FIG. 6 shows a state where an EsSource number the same as the original image data set pair has been assigned to a soft-tissue image data set.

### DESCRIPTION OF THE PREFERRED EMBODIMENT

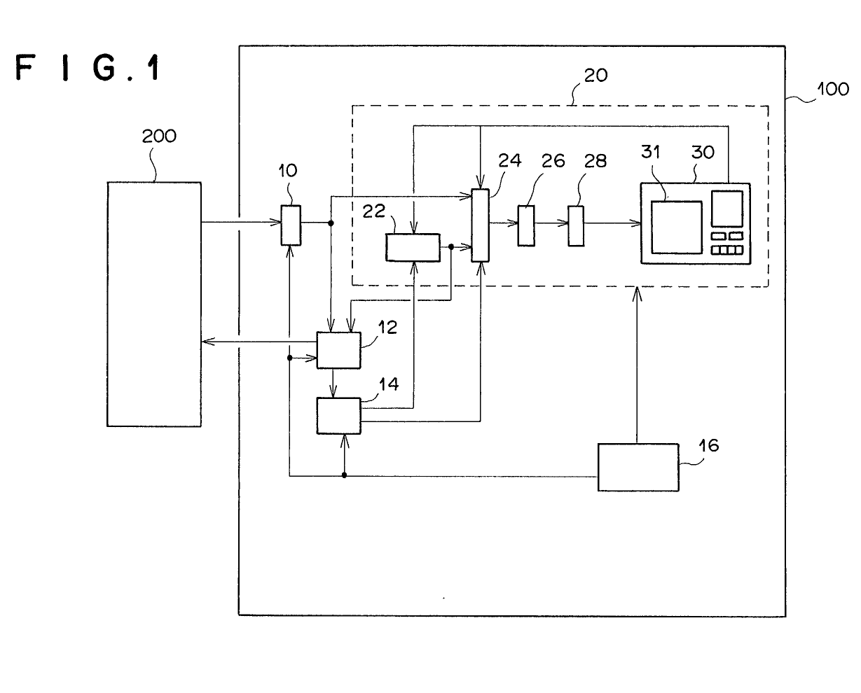

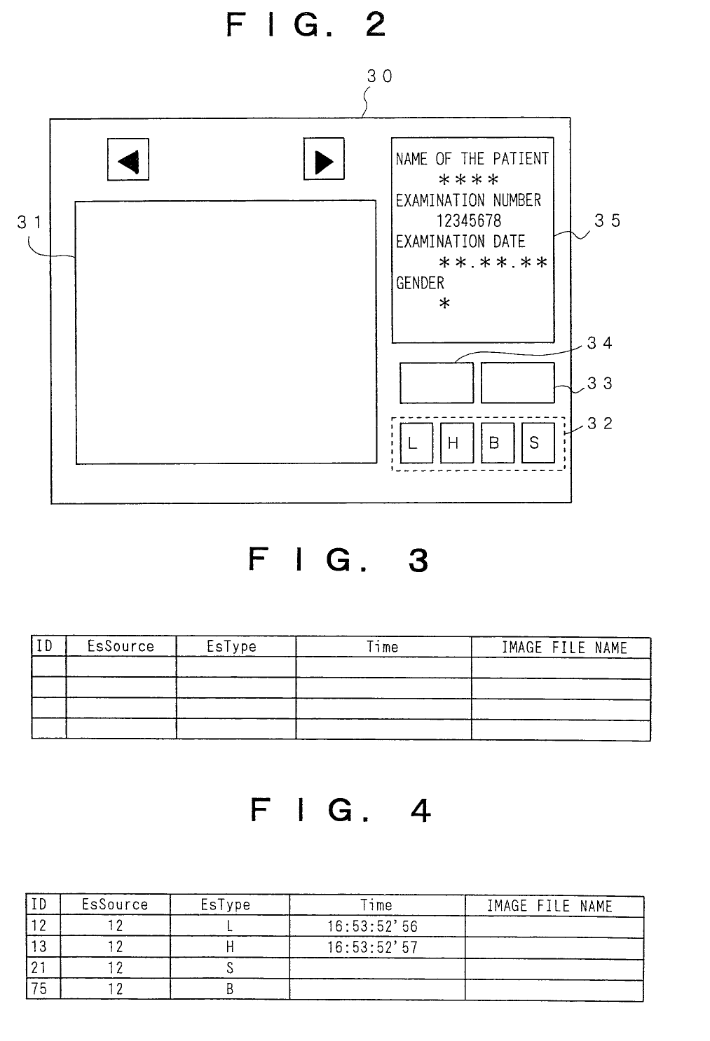

Hereinafter, an embodiment of the present invention will be explained with reference to the accompanying drawings. FIG. 1 is a block diagram showing a configuration of the embodiment of an image data handling apparatus for carrying out an image data handling method of the present invention. FIG. 2 shows an operation panel shown in FIG. 1, and FIGS. 3 to 6 show how information addition means shown in FIG. 1 adds combination information to image data sets.

An image data handling apparatus 100 in this embodiment handles a low-energy image data set and a high-energy image data set used for generating an energy subtraction image data set. The image data handling apparatus 100 comprises a buffer memory 10 for receiving and temporarily storing the low-energy image data set and the high-energy image data set photographed and read by a radiation image photographing/reading apparatus 200, information addition means 12 for adding combination information to the low-energy image data set and the high-energy image data set (hereinafter referred to as the original image data set pair) output from the buffer memory 10 in order to indicate that the original image data set pair belongs to the same combination, storing means 14 for storing the original image data set pair added with the combination information, an image generation unit 20 for obtaining energy subtraction image data sets by carrying out energy subtraction processing on the original image data set pair input from the buffer memory 10 and for displaying images based on the energy subtraction image data sets, and a controller 16 for controlling the information addition means 12, the storing means 14, and the image generation unit 20.

The image generation unit 20 comprises ES processing means 22 as energy subtraction processing means for carrying out the energy subtraction processing on the original image data set pair input from the buffer memory 10 and for outputting a soft-tissue image data set and a bone image data set as the energy subtraction image data sets, image processing means 24 for carrying out image processing on the low-energy image data set, the high-energy image data set, and the energy subtraction image data sets input from the buffer memory 10 and the ES processing means 22, an image memory 26 for storing the image data sets having been subjected to the image processing by the image processing means 24, a video signal processing circuit 28 for outputting display signals by converting the image data sets input from the image memory 26 into video signals, and an operation panel 30 having operation switches for displaying the display signals from the video signal processing circuit 28 as visible images and for carrying out settings related to generation of the images.

The operation panel 30 shown in FIG. 2 has a display unit 31 for displaying the images based on the display signals from the video signal processing circuit 28, image switching buttons 32 as switching means for switching images to be displayed, an ES parameter change switch 33 as subtraction parameter changing means for changing a value of a subtraction parameter used in the ES processing means 22, an image processing parameter change switch 34 as image processing parameter changing means for changing a value of an image processing parameter used in the image processing means 24, and a subject information display unit 35 for displaying subject information that is input from the radiation image photographing/reading apparatus 200 regarding the original image data set pair.

The image switching buttons 32 comprise an L button for displaying a low-energy image, an H button for displaying a high-energy image, a B button for displaying a bone image, and an S button for displaying a soft-tissue image. When one of the buttons 32 is pressed down, the other buttons are pushed up so that only one of the images is selected.

The subtraction parameter change by the ES parameter change switch 33 is applicable to the energy subtraction processing using the original image data set pair belonging to the same combination as the image being displayed on the display unit 31 (that is, the image selected by one of the image switching buttons 32 being pressed down).

The image processing parameter change by the image processing parameter change switch 34 is effective for the image processing to be carried out on the image data set corresponding to the image selected by one of the image switching buttons 32 and being displayed on the display unit 31.

The information addition means 12 uses a combination information format shown in FIG. 3, for adding the combination information to the image data sets. The format has five fields and each of the fields can have up-to-four records (for four lines in the display). The five fields refer to ID, EsSource, EsType, Time, and image file names. Characters and numbers input in the fields have the meanings below.

ID: ID is an identification number for identifying each of the image data sets. The number is unique for each of the image data sets and automatically assigned by the information addition means 12.

EsSource: EsSource is a combination number representing the combination information indicating that the image data sets having a common EsSource number belong to the same combination. The common combination number is automatically assigned by the information addition means 12 to the four records.

EsType: EsType is a symbol representing the low-energy image data set (L), the high-energy image data set (H), the bone image data set (B), and the soft-tissue image data set(s).

Time: Time shows the time of registration of each of the image data sets, and the time is automatically registered by the information addition means 12 according to an instruction from the controller 16.

Image file names: Image file names are names of files for the image data sets. The image file names are assigned to the low-energy image data sets and the high-energy image data sets by the radiation image photographing/reading apparatus 200, and output from the apparatus 200 together with the original image data set pair. For the bone image data set and the soft-tissue image data set generated from the original image data set pair, the image file names are assigned by the image data handling apparatus 100.

Furthermore, the subject information including a name of the subject, an examination number, the date of examination, gender of the subject, weight and height of the subject, and a photographed body part is also added to the low-energy image data set and the high-energy image data set output from the radiation image photographing/reading apparatus 200.

Operation of the embodiment described above will be explained next. The case of handing the original image data set pair input from the buffer memory 10 will be explained first. More specifically, in this case, the image generated by the image processing on the low-energy image data set input from the buffer memory 10 is displayed on the display unit 31, and the original image data set pair belonging to the same combination as the low-energy image data set is read to generate the energy subtraction image data sets.

The information addition means 12 registers photographing based on the instruction from the controller 16. As shown in FIG. 4, the ID field, the EsSource field, and the EsType field in the combination information format used by the information addition means 12 have the numbers and the symbols assigned automatically by the information addition means 12. When the controller 16 issues the instruction to the information addition means 12 for registering photographing wherein the original image data set pair is generated, the information addition means 12 registers the time of receiving the instruction in columns of the Time field for ID12 and ID13 corresponding to the low-energy image data set and the high-energy image data set.

After photographing registration in the combination information format is completed, the time data registered in the Time field are transferred from the image data handling apparatus 100 to the radiation image photographing/reading apparatus 200.

The radiation image photographing/reading apparatus 200 that has received the time data from the image data handling apparatus 100 carries out radiation image photographing and reads the original image data set pair. The original image data set pair is then transferred to the image data handling apparatus 100. The original image data set pair has the file names automatically assigned by the radiation image photographing/reading apparatus 200 and is input to the buffer memory 10. The original image data set pair is then output to the information addition means 12 and to the image processing means 24.

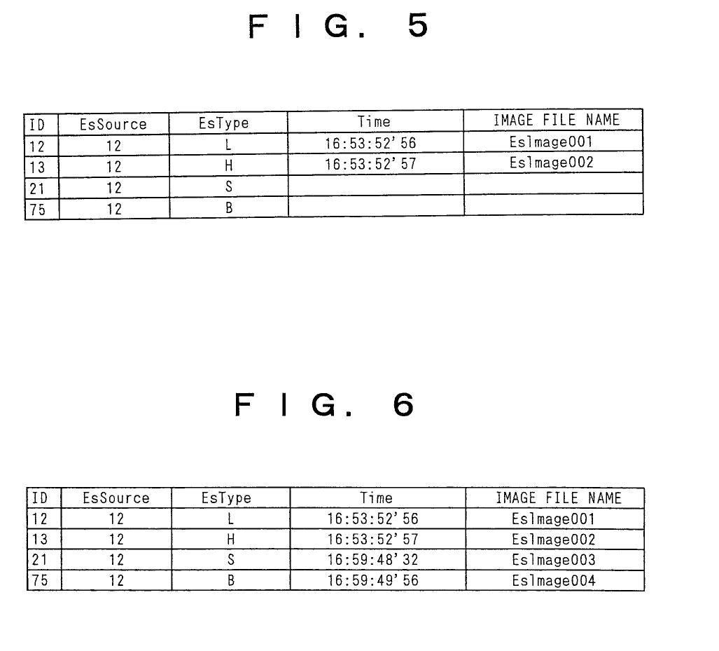

The information addition means 12 receives the original image data set pair, and compares the time data in the combination information format with the time data of the original image data set pair. Based on the time data, the original image data set pair is related to the combination information format. The information addition means 12 stores the file names of the original image data set pair assigned by the radiation image photographing/reading apparatus 200 in corresponding columns of the combination information format related to the original image data set pair, as shown in FIG. 5. In this manner, the low-energy image data set and the high-energy image data set as the original image data set pair have the common EsSource number indicating that the image data sets belong to the same combination.

The combination information format and the original image data set pair are output to the storing means 14 and stored therein.

Meanwhile, in an initial setting of the operation panel 30, the L button in the image switching buttons 32 is pressed down to select and display the low-energy image. Therefore, the low-energy image data set input in the buffer memory 10 is output to the image processing means 24, and the image processing means 24 carries out the image processing on the low-energy image data set while using an initial value that has been set for the image processing parameter (the initial value of the image processing parameter is automatically set based on the subject information input together with the low-energy image data set). The low-energy image data set after the image processing is output to the image memory 26.

The low-energy image data set input to the image memory 26 is displayed as the low-energy image on the display unit 31 of the operation panel 30, via the video signal processing circuit 28. At the same time, the subject information of the low-energy image data set is also displayed in the subject information display unit 35.

If a detailed image of a soft-tissue organ is necessary as a result of observation of the low-energy image displayed on the display unit 31 and the soft-tissue image having been subjected to the energy subtraction processing is needed, the soft-tissue image can be displayed by switching on the S button among the image switching buttons 32.

In other words, by pressing down the S button among the image switching buttons 32, the original image data set pair belonging to the same combination as the low-energy image data set is read from the storing means 14, based on the EsSource number as the combination information of the low-energy image data set. The original image data set pair is then input to the ES processing means 22 and the energy subtraction processing is carried out thereon. In this manner, the soft-tissue image data set is generated, and the soft-tissue image data set has the subject information of the original image data set pair. The soft-tissue image data set is then output to the information addition means 12 and to the image processing means 24.

The soft-tissue image data set input to the information addition means 12 has been generated from the image data sets having the common EsSource number 12 and the ID numbers 12 and 13 as shown in FIG. 6. Therefore, the file name of the soft-tissue image data set is registered (the file name is generated automatically in the image data handing apparatus 100) in columns of the image file name field of ID number 21 (whose EsType is S), as one of the image data sets belonging to the same combination having the common EsSource number 12. Thereafter, the soft-tissue image data set is output to the storing means 14 and stored therein. In this manner, the common EsSource number is assigned to the soft-tissue image data set and to the original image data set pair, indicating that the image data sets belong to the same combination.

Meanwhile, the soft-tissue image data set input to the image processing means 24 is subjected to the image processing, and displayed on the display unit 31 of the operation panel 30 via the image memory 26.

An initial value of the subtraction parameter used in the energy subtraction processing is automatically generated in the ES processing means 22, based on the subject information of the original image data set pair. Likewise, the initial value of the image processing parameter used in the image processing by the image processing means is automatically generated by the image processing means 24, based on the subject information.

In the above example, the soft-tissue image is displayed by pressing down the S button. In order to display the bone image, the B button among the image switching buttons 32 is pressed down. In this manner, the bone image generated by the energy subtraction processing on the original image data set pair is displayed on the display unit 31. The bone image data set generated by the ES processing means 22 is stored in the storing unit 14 as the image data set belonging to the same combination as the soft-tissue image data set having the same EsSource number 12 after the file name thereof is registered in columns of the image file name field for the record whose ID number is 75 (and whose EsType is B).

By adding the combination information indicating that the low-energy image data set and the high-energy image data set belong to the same combination as has been described above, the energy subtraction processing can be carried out immediately and the soft-tissue image or the bone image as the energy subtraction images can be displayed easily.

In this manner, the storing unit 14 stores the four sets of image data (the low-energy image data set, the high-energy image data set, the soft-tissue image data set, and the bone image data set) belonging to the same combination.

How the original image data set pair and the energy subtraction image data sets (that is, the low-energy image data set, the high-energy image data set, the soft-tissue image data set, and the bone image data set) stored in the storing unit 14 are handled will be explained next. More specifically, in the example below, the soft-tissue image data set is read to display the soft-tissue image, and the energy subtraction processing using anew value of the energy subtraction parameter is carried out on the original image data set pair used for generating the soft-tissue image data set. The soft-tissue image based on the soft-tissue image data set after the energy subtraction processing is then displayed.

When the S button among the image switching buttons 32 is pressed in a state where the four image data sets belonging to the same combination (the low-energy image data set, the high-energy image data set, the soft-tissue image data set, and the bone image data set) are stored in the storing unit 14, the soft-tissue image data set stored in the storing unit 14 is input to the image processing means 24. The soft-tissue image data set is subjected to the image processing and displayed as the soft-tissue image on the display unit 31 via the image memory 26 and via the video signal processing circuit 28. The image processing parameter used in the image processing unit 24 has the initial value generated automatically based on the subject information of the original image data set pair.

In the case where a soft-tissue image less affected by bones is necessary as a result of observation of the soft-tissue image, a subtraction parameter change screen is displayed on the display unit 31 when the ES parameter change switch 33 is pressed. According to the screen, the subtraction parameter is adjusted and the energy subtraction processing is carried out by using the new subtraction parameter. In this manner, a soft-tissue image that is more appropriate for observation can be displayed.

In other words, the ES processing means 22 reads from the storing means 14 the original image data set pair belonging to the same combination as the soft-tissue image data set, based on the combination information of the soft-tissue image data set corresponding to the soft-tissue image displayed on the display unit 31. By using the subtraction parameter that has been changed, the energy subtraction processing is carried out on the original image data set pair, and the soft-tissue image data set is generated again. The soft-tissue image data set is displayed as the soft-tissue image on the display unit 31 as in the above example, via the image processing means 24, the image memory 26, and the video signal processing circuit 28. The soft-tissue image data set generated by using the new subtraction parameter is output from the ES processing means 22 to the storing means 24, and the soft-tissue image data set that has been stored in the storing means 14 is overwritten.

In the case where the image processing is carried out again on the soft-tissue image data set by using another image processing parameter value, a screen for changing the parameter used in the image processing (such as tone processing, frequency processing, and standardization processing) is displayed on the display unit 31 by pressing down the image processing parameter change switch 34. According to the display on the screen, the image processing parameter can be changed and the image processing such as enhancing the contrast can be carried out on the image being displayed.

In the above example, the subtraction parameter is changed while the soft-tissue image is being displayed by selection of the S button, and the energy subtraction processing is carried out by using the new subtraction parameter. In order to display the bone image generated by using the new subtraction parameter, the energy subtraction processing is carried out in the same manner when the B button among the image switching buttons 32 is pressed down to display the bone image. In this manner, the bone image based on the bone image data set generated with the new subtraction parameter can be displayed on the display unit 31. The bone image data set generated in the above manner is output to the storing means 14 as in the case of the soft-tissue image data set, and the bone image data set that has been stored in the storing means 14 is overwritten.

By pressing down the H button, the high-energy image data set belonging to the same combination as the image being displayed can be read from the storing means 14 and displayed.

As has been described above, if the low-energy image data set, the high-energy image data set, the soft-tissue image data set, and the bone image data set belonging to the same combination are stored in the storing means 14, the images can be read from the storing means 14 and displayed by switching the image switching buttons 32. However, in the case where the soft-tissue image or the bone image having been subjected to the energy subtraction processing with the new subtraction parameter needs to be displayed, the energy subtraction processing is carried out after the original image data set pair is read from the storing means 14. At this time, the original image data set pair can be found easily in a short time, since the combination information is added to the image data sets indicating that the four data sets belong to the same combination. In this manner, the energy subtraction processing can be carried out easily.

In the case where the soft-tissue image or the bone image is not stored in the storing means 14 when the image is called by the corresponding one of the image switching buttons 32, the original image data set pair belonging to the same combination as the image that is needed is read and input to the ES processing means. The original image data set pair is subjected to the energy subtraction processing therein and the soft-tissue image data set or the bone image data set is generated. In this manner, the soft-tissue image or the bone image that is needed is displayed on the display unit 31.

As has been describe above, since the energy subtraction image data sets, that is, the soft-tissue image data set and the bone image data set have the combination information as image data set specification information for specifying the low-energy image data set and the high-energy image data set used for generating the energy subtraction image data sets, the original image data set pair can be found immediately and the energy subtraction processing can be carried out easily in a short time.

According to the embodiment described above, the images based on the four image data sets (the low-energy image data set, the high-energy image data set, the soft-tissue image data set, and the bone image data set) can be displayed one after another on the display unit 31 by switching the image switching buttons 32. Furthermore, the images generated by changing the subtraction parameter and the image processing parameter can also be displayed for all the image data sets.

Moreover, the information addition means may add, to the low-energy image data set and the high-energy image data set, energy distinction information for distinguishing the low-energy image data set from the high-energy image data set, or subtraction target information indicating that the low-energy image data set and the high-energy image data set are used for generating the energy subtraction image data sets.

The combination information maybe related to a hierarchal level in a hierarchal structure used for image classification and comprising information on patients, examinations, series and individual images. In this manner, a series of images obtained by using a common patient are handled as images belonging to a common series, for example. Therefore, the images belonging to the same patient, the same examination, or the same series can be read and displayed on the display unit so that the images related to the same disease or the like can be easily observed by parallel display or serial display of the images.

In the above embodiment, all the images (the low-energy image, the high-energy image, the energy subtraction images) are displayed one after another. However, not all the images are necessarily displayed one after another. For example, only the low-energy image and the energy subtraction images may be displayed. This is because the high-energy image is used for the energy subtraction processing for generating the soft-tissue image and the bone image and not necessarily used for observation.

In the above embodiment, the combination information format used in the image data handing apparatus is related to the original image data set pair transferred from the radiation image photographing/reading apparatus 200, and the combination information is added to the original image data set pair. However, the combination information is not necessarily added in the above manner, and any method can be adopted for adding the combination information to the original image data set pair. For example, the radiation image photographing/reading apparatus may be included in the image data handling apparatus so that the combination information is added to the original image data set pair by the radiation image photographing/reading apparatus and transferred together with the original image data set pair to the image data handing apparatus for generating the energy subtraction image data sets.

In the above embodiment, the low-energy image data set and the high-energy image data set are stored in the storing means and the energy subtraction image data sets are generated from the low-energy image data set and the high-energy image data set. However, the present invention is not limited to the above example. For example, the image data handling method of the present invention is applicable to an apparatus for carrying out the energy subtraction processing by reading the low-energy image data set and the high-energy image data set stored in a specific apparatus connected thereto by a network or the like. Alternatively, the image data handling method of the present invention may be applied to an apparatus for carrying out the energy subtraction processing on the low-energy image data set and the high-energy image data set transferred thereto.

What is claimed is:

1. An image data handling method for handling a low-energy image data set and a high-energy image data set used for generating an energy subtraction image data set, the image data handling method comprising the step of:
adding combination information to the low-energy image data set and the high-energy image data set for indicating that the low-energy image data set belongs to the same combination as the high-energy image data set.

2. An image data handling method as defined in claim 1, further comprising the step of:
adding the combination information to the energy subtraction image data set generated from the low-energy image data set and the high-energy image data set, for indicating that the energy subtraction image data set belongs to the same combination as the low-energy image data set and the high-energy image data set.

3. An image data handling method for handling an energy subtraction image data set generated from a low-energy image data set and a high-energy image data set, the image data handling method comprising the step of:
adding image data set specification information to the energy subtraction image data set for specifying the low-energy image data set and the high-energy image data set used for generating the energy subtraction image data set.

4. An image data handling apparatus for handling a low-energy image data set and a high-energy image data set used for generating an energy subtraction image data set, the image data handling apparatus comprising:
information addition means for adding combination information to the low-energy image data set and the high-energy image data set for indicating that the low-energy image data set belongs to the same combination as the high-energy image data set.

5. An image data handling apparatus as defined in claim 4, wherein the information addition means adds energy distinction information to the low-energy image data set and the high-energy image data set for distinguishing the low-energy image data set from the high-energy image data set.

6. An image data handling apparatus as defined in claim 4 or 5, wherein the information addition means adds subtraction target information to the low-energy image data set and the high-energy image data set for indicating that the low-energy image data set and the high-energy image data set are used for generating the energy subtraction image data set.

7. An image data handling apparatus as defined in claim 4, wherein the information addition means adds the combination information to the energy subtraction image data set generated from the low-energy image data set and the high-energy image data set for indicating that the energy subtraction image data set belongs to the same combination as the low-energy image data set and the high-energy image data set.

8. An image data handling apparatus as defined in claim 4, wherein the information addition means adds the combination information as series information.

9. An image data handling apparatus as defined in claim 7 or 8, further comprising:
display means for displaying a low-energy image based on the low-energy image data set, a high-energy image based on the high-energy image data set, and an energy subtraction image based on the energy subtraction image data set; and
switching means for carrying out changeover display of the images on the display means.

10. An image data handling apparatus as defined in claim 9, further comprising:
energy subtraction processing means for generating the energy subtraction image data set from the low-energy image data set and the high-energy image data set; and
subtraction parameter changing means for changing a value of a subtraction parameter used by the energy subtraction processing means for generating the energy subtraction image data set.

11. An image data handling apparatus as defined in claim 9, further comprising:
image processing means for carrying out image processing on the image data sets representing the images; and
image processing parameter changing means for changing an image processing parameter used for carrying out the image processing in the image processing means.

12. An image data handling apparatus for handling an energy subtraction image data set generated from a low-energy image data set and a high-energy image data set, the image data handling apparatus comprising:
information addition means for adding image data set specification information to the energy subtraction image data set for specifying the low-energy image data set and the high-energy image data set used for generating the energy subtraction image data set.
